(19) United States
(12) Patent Application Publication
(10) Pub. No.: US 2026/0214393 A1
(43) Pub. Date: Jul. 23, 2026

(54) A MEMS-BASED MICRO SPEAKER DEVICE AND SYSTEM

(71) Applicant: MYVOX AB, Stockholm (SE)

(72) Inventors: Josef HANSSON, Vällingby (SE); Jonatan WÅRDH, Solna (SE)

(73) Assignee: MYVOX AB, Stockholm (SE)

(21) Appl. No.: 19/139,722

(22) PCT Filed: Dec. 21, 2023
(86) PCT No.: PCT/SE2023/051295

§ 371 Date: Jun. 16, 2025

(30) Foreign Application Priority Data
Dec. 22, 2022 (SE) 2251545-6

(51) Int. Cl. H04R 17/10; H04R 7/04; H04R 7/18

(52) U.S. Cl. CPC H04R 17/10; H04R 7/04; H04R 7/18; H04R 2307/025; H04R 2400/11; H04R 2440/01; H04R 2440/07

(57) ABSTRACT

The present invention relates to a MEMS-based micro speaker comprising a support structure with an outer frame part and at least one suspension element, each suspension element being connected to a respective at least one first piezoelectric actuator on the suspension element. The MEMS-based micro speaker further comprises a flexible membrane fixed to the at least one suspension element and connected to a second piezoelectric actuator on the flexible membrane. The flexible membrane is surrounded by the support structure in the plane represented by the outer frame part of the support structure, whereby the suspension resonance frequency is lower than the membrane resonance frequency. A system is also provided comprising such a MEMS-based micro speaker and a controller configured to generate a control signal configured to actuate the at least one first piezoelectric actuator, and to actuate the second piezoelectric actuator.

### TECHNICAL FIELD

The present invention relates generally to miniature-sized sound generators. Especially, the invention relates to a micro-electro-mechanical-system (MEMS) based micro speaker.

### BACKGROUND

The vibration amplitude is a limiting factor for producing sound pressure from small membrane speakers. This is especially the case at lower frequencies. In general, a larger diaphragm dia-10 meter enables a given sound-pressure-level (SPL) at a smaller deflection amplitude. In other words, increased vibration amplitude allows for smaller speakers at the same level of performance.

MEMS based micro speakers are emerging as new technology. In this field, the piezoelectric MEMS micro speaker appear to be the most promising alternative. In its most basic configuration a piezoelectric MEMS micro speaker has a silicon membrane, which is obtained by etching a backside cavity from a silicon chip, and which is actuated by a piezoelectric layer on top of the membrane. The piezoelectric layer is capable to produce high forces. However, for this type of speaker, the vibration amplitude is limited by the tensile tension in the membrane. Moreover, silicon is a relatively stiff material, which also hampers the total amplitude.

The simplest configuration of a piezoelectric MEMS micro speaker is a single membrane actuated by a piezoelectric layer on top. However, as a clamped membrane will undergo tensile as well as bending stress during actuation, the total deflection remains modest.

An alternative design based on suspending the membrane by arms allows for an increased total deflection by suppressing tensile stress. In addition, the resonance frequency of such a system will be lower, allowing for boosted deflection for lower frequencies. Different design of a MEMS-based low frequency speaker (woofer) using suspension of a membrane by arms is shown in the related art document H.-H. Cheng, S.-C. Lo, Z.-R. Huang, Y.-J. Wang, M. Wu, W. Fang, On the design of piezoelectric MEMS microspeaker for the sound pressure level enhancement, Sensors and Actuators A: Physical, Volume 306, 2020, 111960.

Consequently the known MEMS based micro speaker designs leave room for further improvements.

### SUMMARY

The object of the present invention is to eliminate or at least to minimize the problems disclosed above. This is achieved by a MEMS-based micro speaker and a micro speaker system according to the appended independent claims.

In a first aspect of the invention, the MEMS-based micro speaker comprises a support structure comprising an outer frame part and at least one suspension element, each suspension element being connected to a respective at least one first piezoelectric actuator on the suspension element. The at least one first piezoelectric actuator thereby creates bending forces on the at least one suspension element that influence a position of a membrane facing end of the at least one suspension element when a voltage is applied.

The MEMS-based micro speaker further comprises a flexible membrane being fixed to the at least one suspension element wherein the flexible membrane being connected to at least one second piezoelectric actuator on the flexible membrane.

The at least one second piezoelectric actuator thereby creates bending forces on the flexible membrane that deflect the flexible membrane when a voltage is applied.

The flexible membrane is surrounded by the support structure in the plane represented by the outer frame part of the support structure. Thereby, the resonance frequency of each of the at least one suspension element is lower than the actuation frequency of the flexible membrane. In other words, using embodiment presented herein, the dimensions of the at least one suspension element and the flexible membrane are chosen such that the suspension resonance frequency is lower than the membrane resonance frequency.

Thereby, a highly versatile micro speaker is achieved while also being more space efficient than prior art micro speakers. By actuating the at least one suspension element at low frequencies below the resonance frequency of the flexible membrane a “piston mode” is achieved where the flexible membrane vibrates with nearly maximal deflection. By actuating the flexible membrane at higher frequencies above the resonance frequency of the flexible membrane, the membrane itself vibrates in a “drum mode”. Thus, the MEMS-based micro speaker uses the flexible membrane for both low frequencies and high frequencies and thereby provides a space efficient solution with excellent performance. By actuating the suspension elements, the amplitude of the membrane at low frequencies and the sound pressure level (SPL) is also increased compared to prior art solutions using clamped membranes.

Suitably, in embodiments, the MEMS-based micro speaker also comprises a membrane frame fixed to the periphery of the flexible membrane, wherein the flexible membrane is fixed to the at least one suspension element via the membrane frame. Thereby, the membrane frame in combination with the at least one suspension element act as a low pass filter on top of which the flexible membrane can act unperturbed since the membrane frame does not deform. Thus, any bending or buckling of the flexible membrane that could result from the at least one suspension element moving is prevented, since the movement is transferred to the membrane frame and prevented from reaching the flexible membrane itself. Also, it eliminates any need for separate routing for the actuation of the first piezoelectric actuator that actuates the at least one suspension element and the second piezoelectric actuator that actuates the flexible membrane so that a single driving signal or control signal can be used to drive both low frequency modes and high frequency modes of the MEMS-based micro speaker.

Suitably, in one or more embodiments the at least one suspension element extends from the flexible membrane at an angle of at least 45 degrees from a radial direction, preferably at least 60 degrees, more preferably at least 80 degrees. In some of these embodiments, the at least one suspension element extends in a direction tangential to the periphery of the flexible membrane. It is to be understood that the tangential direction includes substantially tangential directions. By the suspension element(s) extending or having their main extension in a direction that deviates significantly from the radial direction, this increases a stroke length of the at least one suspension element and thereby also the amplitude at low frequencies for the MEMS-based micro speaker compared to if the suspension element would extend radially from the flexible membrane. Providing the at least one suspension element to extend in a tangential main direction or at an angle of at least 45 degrees from a radial direction, preferably at least 60 degrees from a radial direction, more preferably at least 80 degrees from a radial direction, from their attachment to the flexible membrane is thus advantageous both in comparison to providing the at least one suspension element to extend substantially radially from the flexible membrane and in comparison to prior art solutions using clamped membranes.

Also, each of the at least one suspension element may be arranged to pivot around a first axis, wherein the first axis is radially directed towards the center of the flexible membrane through the center of the suspension element. Thereby, the amplitude of the MEMS-based micro speaker is increased since the stroke length of the at least one suspension element is increased.

Suitably, the flexible membrane is in one or more embodiments made of silicon. This is a highly suitable material that is both flexible and durable, thereby ensuring a long lifetime and a continuously high performance also when the MEMS-based micro speaker is used for long durations of time.

The membrane frame may also be made of silicon and the cross-section thickness of the membrane frame may be larger than the thickness of the flexible membrane, thereby making the membrane frame less flexible than the flexible membrane. This is also advantageous in rendering the membrane frame sturdy enough to avoid transmitting movements that could cause undesired buckling or flexing of the flexible membrane as the at least one suspension element moves at low frequencies. Furthermore, it is advantageous to use silicon for both the membrane frame and the membrane itself since this renders manufacture significantly easier than when different materials are used and since the risk of damage or even tears to the flexible membrane at its attachment to the membrane frame is avoided.

In some embodiments, each of the at least one suspension element is fixed to the flexible membrane directly or via the membrane frame, along a first attachment section on the periphery of the flexible membrane or the membrane frame, the length of the attachment section being less than 10 % of the length of the periphery of the flexible membrane or the membrane frame. Thereby, movement of the at least one suspension element in relation to the flexible membrane or membrane frame is improved, providing a larger vertical gap for the MEMS-based micro speaker and hence greater amplitude in “piston mode”.

In some embodiments, each of the at least one suspension element is fixed to or extends as an integrated part from the outer frame part along a second attachment section, the length of the second attachment section being less than 10 % of the length of the periphery of the flexible membrane. Thereby, movement of the at least one suspension element in relation to the outer frame is improved, providing a larger vertical gap for the MEMS-based micro speaker and hence greater amplitude in “piston mode”.

Also, in some embodiments the membrane frame may consist of thin walls arranged in a truss structure. Thereby, a highly stable membrane frame with a low mass is achieved, thereby facilitating the design of the membrane frame to select a suitable resonance frequency. By adjusting the width and spacing of the walls, the total mass of the membrane frame can be adjusted without overly affecting the mechanical behaviour of the membrane frame.

The MEMS-based micro speaker may suitably also comprise a flexible polymer membrane covering the at least one suspension element, the flexible membrane, and the support structure, such that:
in a neutral positioning of the at least one suspension element, the flexible polymer membrane is folded to form a fold between a respective outer edge of each suspension element and the outer frame part of the support structure, and
in a first extreme positioning of the at least one suspension element, the flexible polymer membrane is unfolded to cover a spacing between the respective outer edge of each suspension element and the outer frame part of the support structure.

Thereby, the flexible polymer membrane is arranged to prevent fluid leakage between at least one suspension element and the support structure as well as between the at least one suspension element and the flexible membrane, whereby fluid leakage and resulting losses in SPL is prevented in a highly convenient and efficient manner without requiring additional space or affecting the performance of the MEMS-based micro speaker.

In some embodiments, the flexible membrane has a curved or circular outline and each of the at least one suspension element has the shape of:
a single continuous curve extending in a direction tangential to the periphery of the flexible membrane, or
two or more connected curve segments, each extending in a direction tangential to the periphery of the flexible membrane.

Thereby, the advantages of a large stroke of the at least one suspension element is achieved, giving the high amplitude of the flexible membrane while at the same time providing a highly compact and space efficient MEMS-based micro speaker.

In some embodiments, the flexible membrane has a rectilinear outline and each of the at least one suspension element has the shape of:
a single elongated rectilinear segment extending in a direction tangential to the adjacent periphery of the flexible membrane, or
two or more connected elongated rectilinear segments, each extending in a direction tangential to the adjacent periphery of the flexible membrane.

This is also a highly advantageous design, providing the desirable large stroke and high amplitude while at the same time being space efficient and compact.

In a second aspect, the present invention also refers to a micro speaker system comprising a MEMS-based micro speaker comprising a support structure comprising an outer frame part and at least one suspension element being connected to a respective at least one first piezoelectric actuator, and a flexible membrane being fixed to the at least one suspension element, the flexible membrane being connected to a second piezoelectric actuator. The flexible membrane is surrounded by the support structure in the plane represented by the outer frame part of the support structure. Thereby, the resonance frequency of each of the at least one suspension element is lower than the actuation frequency of the flexible membrane. In other words, using embodiment presented herein, the dimensions of the at least one suspension element and the flexible membrane are chosen such that the suspension resonance frequency is lower than the membrane resonance frequency. The micro speaker system also comprises a controller configured to generate a control signal configured to actuate the first piezoelectric actuator, and to actuate the second piezoelectric actuator. Thereby, the advantages of the MEMS-based micro speaker are realized in a micro speaker system.

Suitably, the MEMS-based micro speaker is the MEMS-based micro speaker according to any embodiment of the invention. Thereby, any of the embodiments of the MEMS-based micro speaker may be used in the micro speaker system.

The first piezoelectric actuator of each of the at least one suspension element may be controllable in response to the control signal so as to influence a position of the membrane facing end of the suspension element, which is attached to the flexible membrane directly or via the membrane frame, along a second axis perpendicular to a plane represented by the outer frame part of the support structure. Thereby, operation of the MEMS-based micro speaker is achieved in a convenient way at low frequencies.

Also, the second piezoelectric actuator may be controllable in response to the control signal so as to deflect the flexible membrane. Thereby, operation of the MEMS-based micro speaker is achieved in a convenient way at high frequencies.

Any advantage described in connection with one aspect of the invention is equally applicable to corresponding embodiments of other aspects of the invention.

Many additional benefits and advantages of the present invention will be readily understood by the skilled person in view of the detailed description below.

### DRAWINGS

The invention will now be described in more detail with reference to the appended drawings, wherein:

FIGS. 1a-b schematically show a MEMS-based micro speaker according to a first embodiment of the invention;

FIGS. 2a-b schematically show a MEMS-based micro speaker according to a second embodiment of the invention;

FIG. 3 schematically shows a MEMS-based micro speaker system according to an embodiment of the invention;

FIG. 4 schematically shows a membrane frame consisting of thin walls arranged in a truss structure;

FIGS. 5a-e show various example geometries of a MEMS-based micro speaker according to embodiments herein;

FIGS. 6A-C illustrate examples of membrane configurations;

FIGS. 7a-b schematically show a MEMS-based micro speaker according to embodiments herein, further being covered by a flexible polymer membrane;

FIG. 8 schematically shows a MEMS-based micro speaker according to a third embodiment of the invention;

FIG. 9 illustrates deflection of a suspension element and a flexible membrane in “piston mode”;

FIGS. 10a-c illustrate example configurations of piezoelectric layers;

FIG. 11 illustrates deflection of a flexible membrane in “drum mode”; and

FIG. 12 illustrates deflection of a suspension element and a flexible membrane in a combined “piston mode” and “drum mode”.

All the figures are schematic, not necessarily to scale, and generally only show parts which are necessary in order to elucidate the respective embodiments, whereas other parts may be omitted or merely suggested. Any reference number appearing in multiple drawings refers to the same object or feature throughout the drawings, unless otherwise indicated.

### DETAILED DESCRIPTION

Many loudspeaker applications utilize several speaker membranes tuned for different frequencies in order to get a good response over the entire hearable frequency range (woofers for low frequencies and tweeters for high). This is an alternative for MEMS microspeakers as well, as e.g. a clamped membrane is suited for higher frequencies while the above mentioned suspended membrane in H.-H. Cheng, S.-C. Lo, Z.-R. Huang, Y.-J. Wang, M. Wu, W. Fang, On the design of piezoelectric MEMS microspeaker for the sound pressure level enhancement, Sensors and Actuators A: Physical, Volume 306, 2020, 111960 is suited for lower frequencies. In fact, H.-H. Cheng, S.-C. Lo, Z.-R. Huang, Y.-J. Wang, M. Wu, W. Fang, On the design of piezoelectric MEMS microspeaker for the sound pressure level enhancement, Sensors and Actuators A: Physical, Volume 306, 2020, 111960 proposes combining its woofer with a separate tweeter to provide a full range speaker.

However, for micro speakers the device size is at a premium, so several separate speakers are undesirable. There is provided a micro-electro-mechanical system (MEMS) based micro speaker and system to solve the problem of how to provide a sufficient sound pressure level (SPL) both at low frequencies and at high frequencies. Attempts have also been made to combine a woofer and a tweeter in a single MEMS device, e.g. in the related art document F. Stoppel, C. Eisermann, S. Gu-Stoppel, D. Kaden, T. Giese and B. Wagner, “Novel membrane-less two-way MEMS loudspeaker based on piezoelectric dual-concentric actuators,” 2017 19th International Conference on Solid-State Sensors, Actuators and Microsystems (TRANSDUCERS), 2017, pp. 2047-2050, doi: 10.1109/TRANSDUCERS.2017.7994475, wherein two concentric actuators are used for the woofer and the tweeter, respectively. The aim of the disclosed solution is to obtain a decoupled device that behaves like a closed membrane, without only very narrow vertical gaps separating the actuators. This is disadvantageous, because the deflection amplitude of the woofer will be limited, and the dual actuators require separate space on the chip which adds to the size of the speaker.

The inventors have realized that there is a tradeoff between membrane size, SPL at low frequencies, and low resonance frequency, which means that a larger membrane (to obtain stronger sound at low frequencies) causes higher frequencies to drop off. The inventors have further realized that while obtaining low frequency sound using the suspension (piston mode), higher frequencies can at the same time be obtained by separately actuating the suspended membrane at a higher resonance frequency. Thereby, the space allocated by the membrane can be used to create sound at higher frequencies (tweeter), meaning that almost all of the actuating chip area is reused for both the woofer and the tweeter. Hence, a highly versatile micro speaker according to embodiments herein is achieved while also being more space efficient than prior art micro speakers.

Herein, a “MEMS element”, “MEMS component” or “MEMS structure” refers to a functional device that is three-dimensionally formed by using a technique for manufacturing a MEMS.

It is noted that all sizes, angles, relations etc. given herein are not to be seen as only covering the exact given values but also include minor variations due to manufacturing tolerances. It is also to be noted that features from the various embodiments described herein may freely be combined, unless it is explicitly stated that such a combination would be unsuitable.

It is also to be noted that features from the various embodiments described herein may freely be combined, unless it is explicitly stated that such a combination would be unsuitable, and further that the invention is not restricted to the described embodiments in the figures but may be varied freely within the scope of the claims.

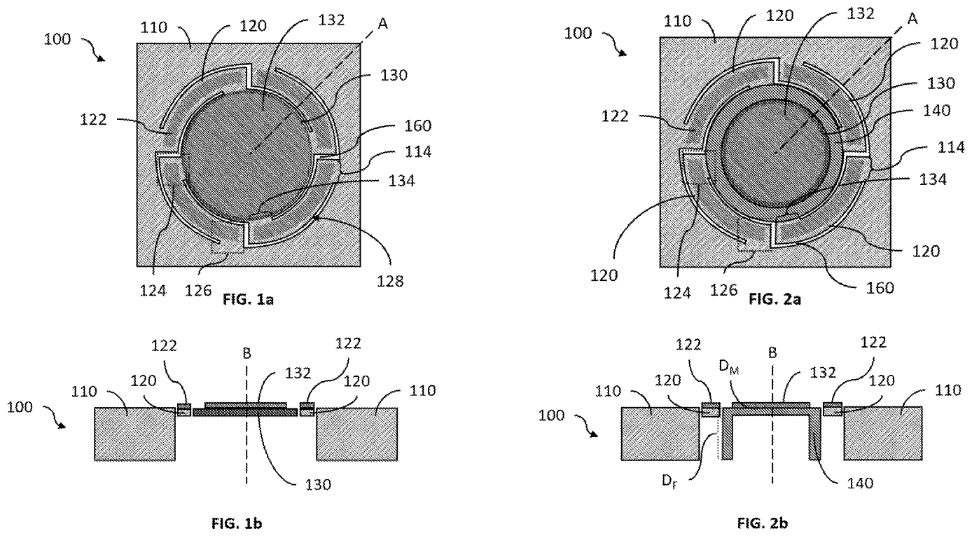

In a first aspect of the invention, a MEMS-based micro speaker will first be described in a first embodiment with reference to FIGS. 1a and 1b, and in a second embodiment with reference to FIGS. 2a and 2b.

FIG. 1a shows a MEMS-based micro speaker according to a first embodiment in a top view, and FIG. 1b shows the same MEMS-based micro speaker in a side view.

The MEMS-based micro speaker in FIG. 1a and b comprises a support structure 100 having an outer frame part 110 and at least one suspension element 120. Each of the at least one suspension element 120 is connected to a respective at least one first piezoelectric actuator 122 on the suspension element 120. Thereby, each suspension element 120 can be set into motion by actuation of the respective first piezoelectric actuator 122. The MEMS-based micro speaker also comprises a flexible membrane 130 being fixed to the at least one suspension element 120. The flexible membrane 130 is connected to at least one second piezoelectric actuator 132 on the flexible membrane 130. In other words, the flexible membrane 130 is suspended by the at least one suspension element 120, wherein the at least one suspension element 120 is/are actuated by piezoelectricity, and the flexible membrane 130 is also actuated by piezoelectricity, using separate, independent, first and second piezoelectric actuators 122, 132.

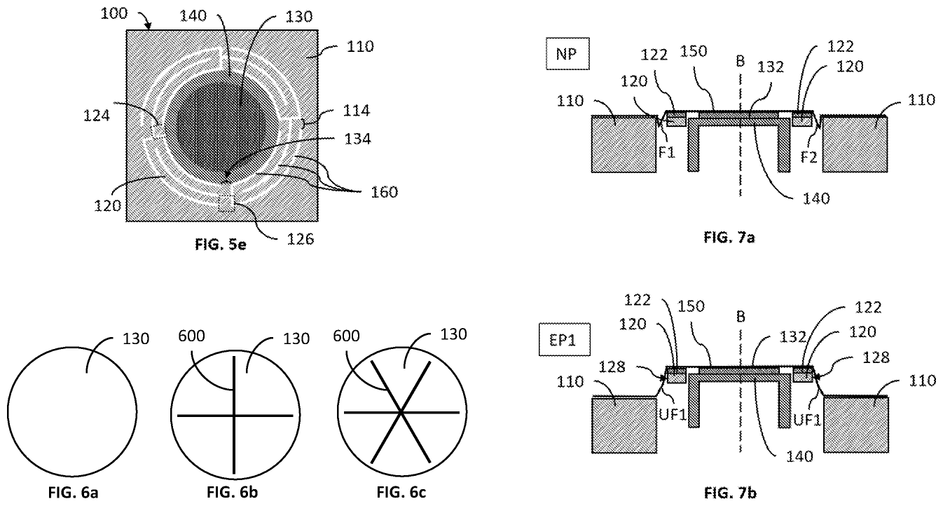

As is understood by the skilled person, the number of suspension elements 120 may be varied to suit different applications. For example, there may be one, two, three, four, five or six suspension elements 120, depending on the configuration and geometry of the MEMS-based micro speaker. Some non-limiting examples of MEMS-based micro speakers according to the invention, having different numbers and arrangement of suspension elements 120, are shown in FIGS. 5a to 5e. To achieve optimal stability of the device while at the same time achieving the greatest possible stroke length for the suspension elements 120, three or four suspension elements 120 are typically preferred. The suspension elements may be in the form of cantilevers or suspension arms, but other options are also applicable.

FIG. 5a to e show various non-limiting examples of geometries of a MEMS-based micro speaker. The flexible membrane 130 may have a curved or circular outline, as in the examples of FIGS. 5a, 5b, 5d and 5e. In these embodiments, each of the at least one suspension element 120 has the shape of a single continuous curve, as exemplified in FIGS. 5a and 5b, or two or more connected curve segments, as exemplified in FIGS. 5d and 5e. Each curve or curve segment suitably extends at an angle of at least 45 degrees from a radial direction, preferably at least 60 degrees, more preferably at least 80 degrees from the periphery of the flexible membrane 130, possibly in a direction tangential to the periphery of the flexible membrane 130. In other embodiments, as exemplified in FIG. 5c, the flexible membrane 130 has a rectilinear outline and each of the at least one suspension element 120 has the shape of a single elongated rectilinear segment or two or more connected elongated rectilinear segments (not shown in figure). Each segment extends in a direction tangential to the periphery of the flexible membrane 130, 830.

The first and second piezoelectric actuators connected to the at least one suspension element 120 and the flexible membrane 130, respectively, are not shown in the FIGS. 5a to 5c. This is only for illustrational purposes, to enable a better view of the differing exemplary configurations and geometries of the at least one suspension element 120 and the flexible membrane 130.

In the context of this disclosure, that two elements are connected means that they are in contact and that a movement or force can be transferred from the first element to the second element, or vice versa. For instance, a movement or force can be transferred from the at least one first piezoelectric actuator 122 to the respective at least one suspension element 120 to which it is connected, and vice versa. In another example, a movement or force can be transferred from the at least one second piezoelectric actuator 132 to the flexible membrane 130 to which it is connected, and vice versa.

The flexible membrane 130 is surrounded by the support structure 100 in the plane represented by the outer frame part of the support structure 100. Thereby, the resonance frequency of each of the at least one suspension element is lower than the actuation frequency of the flexible membrane. In other words, using embodiment presented herein, the dimensions of the at least one suspension element 120 and the flexible membrane 130 are chosen such that the suspension resonance frequency is lower than the membrane resonance frequency.

The suspension resonance frequency is the resonance frequency of the sub-system comprising the at least one suspension element 120, with the weight and in applicable cases also geometry of any components suspended by the at least one suspension element 120 taken into consideration. The suspension resonance frequency may be determined in any manner known in the art. The suspension resonance frequency is separate from the membrane resonance frequency, which is the resonance frequency of the flexible membrane 130.

Since the flexible membrane 130 in the MEMS-based micro speaker according to embodiments herein is surrounded by the at least one suspension element 120, and other parts of the support structure 100, the flexible membrane is relatively smaller (smaller rectilinear width, smaller circumference or other suitable measure depending on the shape of the membrane) compared to the surrounding parts of the micro speaker. Thereby, the relation that the suspension resonance frequency is lower than the membrane resonance frequency will typically be fulfilled for all embodiments herein. For instance, it is true for all example embodiments illustrated in FIGS. 1a-b, 2a-b, 4a-e, 7a-b, and 10a-c. As shown in the figures, that the flexible membrane 130 in the MEMS-based micro speaker is surrounded by the at least one suspension element 120 and the other parts of the support structure 100 mean that all the sound generating elements, i.e., the at least one suspension element 120 with the first piezoelectric actuator 122 and the flexible membrane 130 with the second piezoelectric actuator 132 can be arranged in a single plane. Herein, this plane is referred to as the plane represented by the outer frame part 110 of the support structure 100, 800. Of course, each of the at least one suspension element 120 may have a three-dimensional design, in more than one layer, as long as the membrane facing end of each suspension element 120 is in the plane of the flexible membrane 130. Thereby, although one or more first piezoelectric actuator 122 may be arranged out of this plane, the advantageous maximization of surface area for both the piston mode and drum mode actuation of the flexible membrane 130, as described herein, is still achieved. A space efficient micro speaker with excellent performance enabling high sound pressure for both high and low frequencies is thereby still achieved, as the sound generating surface area as seen in a top view can be maximized. In these embodiments, even higher deflection may be obtained in the piston mode. For the one plane embodiment on the other hand, wherein all parts each of the at least suspension element 120 are arranged in the same plane as the flexible membrane 130, the additional advantage that the micro speaker is also minimized in height is further achieved.

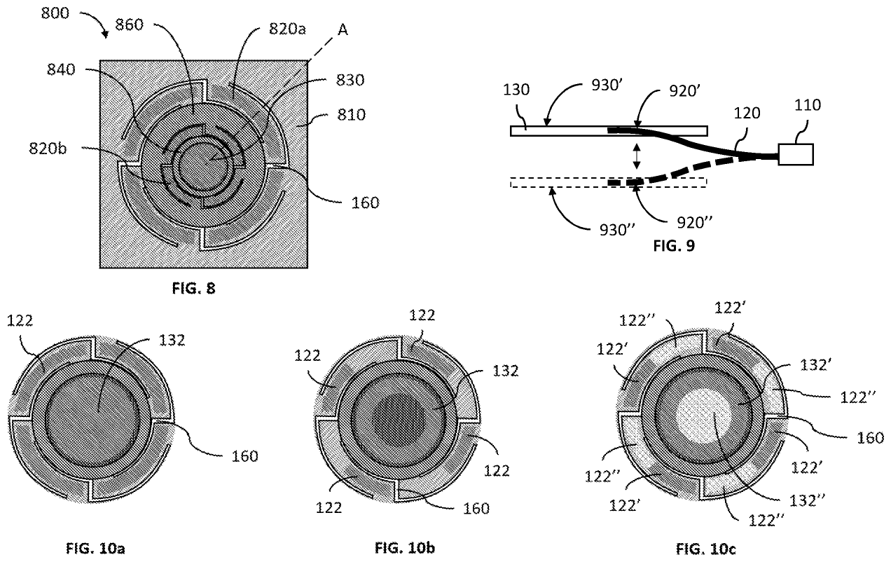

Thereby, below the membrane resonance frequency, actuation of the at least one first piezoelectric actuator 122 and thereby the respective suspension element 120 to which it is connected will cause the MEMS-based micro speaker to act as a piston, with nearly maximal deflection across the entire surface of the suspended flexible membrane 120. In other words, the actuation of the at least one suspension element 120 causes the entire flexible membrane 130 to vibrate as a piston, in “piston mode”, for low frequencies. The flexible membrane 130 can thereby be set in motion by the at least one suspension element 130, as the at least one suspension element 130 is/are attached to the flexible membrane 130 and hence operatively connected so that forces and movements can be transferred between them. That the entire flexible membrane 130 vibrates as a piston, in “piston mode”, for low frequencies may also be referred to as the suspended flexible membrane 130 acting as a woofer for frequencies below the resonance frequency of the flexible membrane 130. This is illustrated in FIG. 9, structurally showing, in a side view, a suspension element 120 which during actuation and deflection moves between a first position 920′and a second position 920″. FIG. 9 also shows the resulting movement of a flexible membrane 130 attached to the suspension element 120 between a corresponding first membrane position 930′and second membrane position 930″, as indicated by the double arrows. As is illustrated in the figure, the flexible membrane 130 is not actuated and thus does not deform, since the actuation frequency is in this case below the membrane resonance frequency. The flexible membrane 130 is in such cases a passive component contributing only to the deflection of the suspension sub-system, i.e. the woofer.

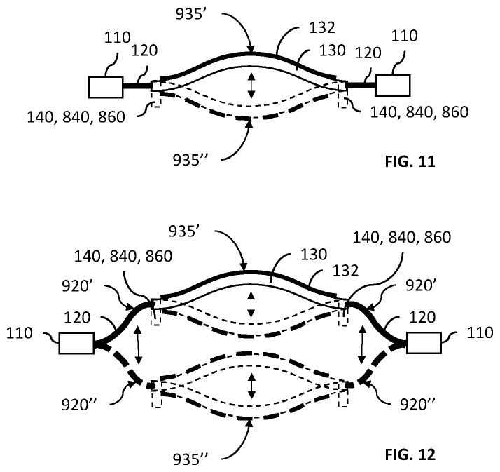

If the MEMS-based micro speaker is driven using frequencies above the membrane resonance frequency, thereby actuating the at least one second piezoelectric actuator 132 connected to the flexible membrane 130, sound at higher frequencies is generated. This may also be referred to as the suspended flexible membrane 130 acting as a tweeter for frequencies above the resonance frequency. In this case, the flexible membrane 130 may be said to act in “drum mode”, acting similarly to a clamped membrane but with smaller attachment sections to the support structure 100, leading to comparably less deflection amplitude. FIG. 11 structurally shows, in a side view, a flexible membrane 130 which during actuation of the at least one second piezoelectric actuator 132 deflects and vibrates in “drum mode” between a first membrane deflection position 935′and an opposing second membrane deflection position 935″, as indicated by the double arrows. FIG. 11 shows that the flexible membrane 130 is attached to at least one suspension element 120, in the figure illustrated by two suspension elements 120, which is in the example of FIG. 11 not actuated and hence does not cause the flexible membrane 130 to move as a piston between the first position 920′and the second position 920″ shown in FIG. 9, because the actuation frequency is in this case above the membrane resonance frequency. Optionally, a membrane frame 140, 840, 860 according to any embodiment described in connection with FIGS. 2a, 2b, 4 and 8 may be included.

The MEMS-based micro speaker may be driven by actuating the at least one first piezoelectric actuator 122 using frequencies below the membrane resonance frequency and simultaneously actuating the at least one second piezoelectric actuator 132 using frequencies above the membrane resonance frequency. As illustrated in the side view of FIG. 12, the actuation of the at least one first piezoelectric actuator 122 and thereby the respective suspension element 120 to which it is connected will cause the MEMS-based micro speaker to act as a piston, with nearly maximal deflection across the entire surface of the suspended flexible membrane 120 as the at least one suspension element 120 moves between its first position 920′and its second position 920″, and the simultaneous actuation of the at least one second piezoelectric actuator 132 will cause the flexible membrane 130 to also deflect and vibrate in “drum mode” between the first membrane deflection position 935′and the second membrane deflection position 935″. Thereby, sound at both lower frequencies (woofer) and higher frequencies (tweeter) can be generated simultaneously. In this embodiment, it is preferable to include an optional membrane frame 140, 840, 860 according to any embodiment described in connection with FIGS. 2a, 2b, 4 and 8. The inclusion of such a membrane frame 140, 840, 860 advantageously minimizes the mechanical crosstalk between the at least one suspension element 120, 820 and the flexible membrane 130, 830, and thereby prevents the flexible membrane 130, 830 from being deformed by the movements of the at least one suspension element 120, 820. In other words, the flexible membrane 130, 830 is deflected through actuation of at least one second piezoelectric actuator 132, but is not deflected (or at least minimally deflected) by transferred movements of the at least one suspension element 120, 820 caused by actuation of the at least one second piezoelectric actuator 132. This is further described in connection with FIGS. 2a and 2b.

It is noted that in the embodiment of FIG. 12, one of the generated frequencies (high or low) will always be dominant over the other one.

Thereby, a highly versatile micro speaker is achieved while also being more space efficient than prior art micro speakers. Embodiments of the invention further enable providing a full spectrum micro speaker in this space efficient manner. This is because the flexible membrane 130 can be arranged to cover a large part of the area of the micro speaker, as seen in a top view, and the area of the flexible membrane 130 is reused for both low and high frequency sound generation in the piston mode and the drum mode, respectively, as described in embodiments herein. This is highly advantageous for applications requiring miniaturization, such as e.g. mobile telephony speakers or in-ear speakers.

FIG. 2a shows a MEMS-based micro speaker according to a first embodiment in a top view, and FIG. 2b shows the same MEMS-based micro speaker in a side view.

The MEMS-based micro speaker of FIG. 2 is similar to that of FIG. 1 (the first embodiment) but in this second embodiment, the MEMS-based micro speaker further comprises a membrane frame 140 fixed to the flexible membrane 130. Thereby, in this embodiment the flexible membrane 130 is fixed to the at least one suspension element 120 via the membrane frame 140.

Typically, the membrane frame 140 is fixed to the periphery of the flexible membrane 130 or fixed to the flexible membrane 130 in another manner that enables it to hold up the flexible membrane frame 130.

By adding the supporting membrane frame 140, the membrane frame 140 in combination with the at least one suspension element function as a low pass filter on-top of which the flexible membrane 130 can act unperturbed, since the membrane frame 140 remains undeformed. In other words, the displacement from the at least one suspension element 120 that would otherwise have been transferred to the flexible membrane 130, causing it to buckle or go into “drum mode”, is instead transferred to the membrane frame 140. This minimizes the mechanical crosstalk from the at least one suspension element 120 and the flexible membrane 130, and thereby prevents the flexible membrane 130 from being deformed by the movements of the at least one suspension element 120.

Thereby, instead of optimizing the behavior of the suspended flexible membrane regarding the trade-off between high and low frequency behavior, embodiments herein utilize this trade-off to its advantage.

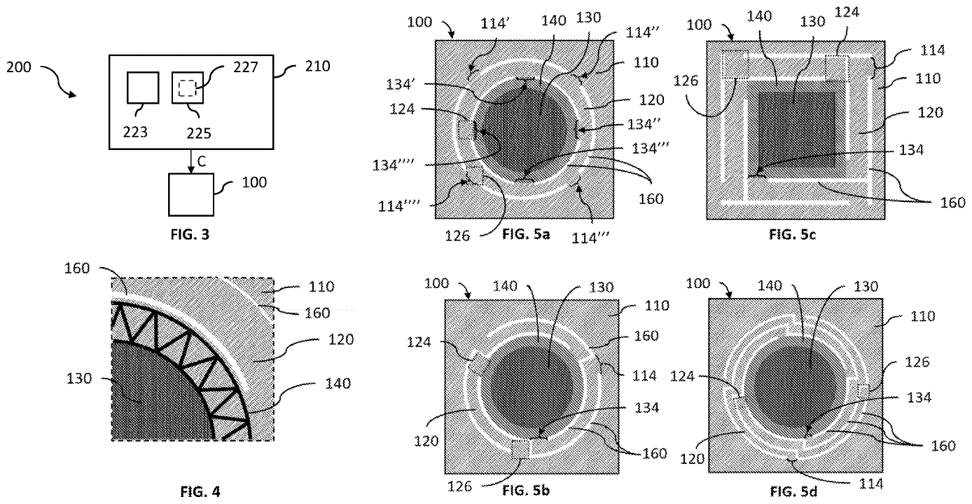

In addition, this means that there is advantageously no need for separate routing for the actuation of the first piezoelectric actuator 122 (actuating the at suspension element(s) 120) and the second piezoelectric actuator 132 (actuating the flexible membrane 130). Thereby, using embodiments of the invention, a single driving signal, or control signal, can be used to drive both low frequency modes, the “woofer”, and high frequency modes, the “tweeter”, of the MEMS-based micro speaker. The driving signal or control signal can be the control signal C generated by the controller 210 described in connection with FIG. 3.

As illustrated in FIGS. 1a-b, 2a-b, 4, 5a-e, 8 and 10a-c, there are narrow gaps 160 between parts of the MEMS-based micro speaker that are moveable relative to each other, e.g. between the flexible membrane and each of the at least one suspension element adjacent to the flexible membrane, between a first suspension element and a second suspension element if the second suspension element encloses the first one as is e.g. the case in FIG. 5d, between a first suspension element part and a second suspension element part if the second suspension element part encloses the first one as is e.g. the case in FIG. 5e, and between the outermost suspension element(s) and the outer frame part 110, 810 of the support structure 100, 800.

In the non-limiting examples of FIGS. 1a-b and 2a-b the MEMS-based micro speaker is illustrated as comprising a circular flexible membrane 130 and four single curved suspension elements 120 extending along the periphery of the circular flexible membrane 130. However, the membrane may of course have other shapes than circular, for instance have a rectilinear outline. Different numbers and configurations of the suspension elements 120 may also be used within the scope of the present invention, for example as described in connection with FIG. 5a to e.

The MEMS-based micro speaker according to any embodiment described herein may comprise more complex structures, such as an entire woofer-tweeter nested inside the first. This is illustrated in the non-limiting example of FIG. 8 which schematically a third embodiment of the MEMS-based micro speaker according to the in. In FIG. 8, the MEMS-based micro speaker comprises a support structure 800 and, at the center of the device, a flexible membrane 830 being connected to a second piezoelectric actuator (not shown in the figure) in the same manner as in the embodiments described in connection with FIGS. 1a, 1b, 2a and 2b. In FIG. 8, the support structure 800 comprises, in order from the periphery of the support structure 800 towards its center: an outer frame part 810; a first set of at least one suspension elements 820a being connected to a respective at least one first piezoelectric actuator (not shown in the figure) in the same manner as in the embodiments described in connection with FIGS. 1a, 1b, 2a and 2b; and a second set of at least one suspension element 820b being connected to a respective at least one third piezoelectric actuator (not shown in the figure) in the same manner as in the embodiments described in connection with FIGS. 1a, 1b, 2a and 2b. The MEMS-based micro speaker of FIG. 8 further comprises a membrane frame 840 being fixed to the periphery of the flexible membrane 830 and further being fixed to the membrane facing end of each of the at least one suspension element 820b in the second set. The nested MEMS-based micro speaker further comprises, between the first and second set of at least one suspension element 820a, 820b, an intermediate frame 860 being fixed to the inward facing/membrane facing end of each of the at least one suspension element 820a in the first set, and being fixed to the outward facing end of each of the at least one suspension element 820b in the second set. Both the membrane frame 840 and the intermediate frame 860 may be realized according to any of the embodiments of membrane frame 140 described herein and contribute to the same advantages. More levels of nesting are also possible if this is suitable to the application.

Although the illustration in FIG. 8 shows a circular membrane and curved suspension elements, nesting is of course equally applicable using a membrane and suspension elements having rectilinear outlines or other suitable geometries apparent to the skilled person. In these embodiments, the flexible membrane 130 is surrounded by at least one suspension element 820b in the second set in the plane represented by the outer frame part 810 of the support structure 800, and the at least one suspension element 820b in the second set is in turn surrounded by the at least one suspension element 820a in the first set, in the same plane. Thereby, the resonance frequency of each of the at least one suspension element 820a in the first set is lower than the actuation frequency of the at least one suspension element 820b in the second set, and the resonance frequency of each of the at least one suspension element 820b in the second set is lower than the actuation frequency of the flexible membrane 830. In other words, using embodiment presented herein, the dimensions of the at least one suspension element 820a in the first set, the at least one suspension element 820b in the second set, and the flexible membrane 830 are chosen such that the resonance frequency of each of the at least one suspension element 820a in the first set is lower than the resonance frequency of each of the at least one suspension element 820b in the second set, and further such that the resonance frequency of each of the at least one suspension element 820b in the second set is lower than the actuation frequency of the flexible membrane 830.

The nesting thereby suitably creates three (in the illustrated example, more levels of nesting are plausible) drivers nested inside each other, which are suitably tuned for three different frequency bands. As mentioned herein, the membrane frame 840, and, in the nested MEMS-based micro speaker, also the intermediate frame(s) 860 function as lowpass filters.

A membrane frame 140, 840 or intermediate frame 860 may suitably be created by leaving material when etching the back cavity of the MEMS-based micro speaker, leading to a frame height equal to the overall chip thickness, as illustrated in FIG. 2b, or it can be tuned to a desired height in an additional selective etching step.

In any embodiment herein, the at least one suspension element 120, 820a, 820b may extend from the flexible membrane 130, 830 at an angle of at least 45 degrees from a radial direction, preferably at least 60 degrees, more preferably at least 80 degrees. In some of these embodiments, the at least one suspension element 120, 820a, 820b extends in a direction tangential to the periphery of the flexible membrane 130, 830. It is to be understood that the tangential direction includes substantially tangential directions.

The extension of a suspension element 120 is herein defined as the extension between a first end part 124 (illustrated for one suspension element each in FIGS. 1a, 2a and 5a-e) of the suspension element 120, the first end part 124 being attached to the flexible membrane 130, either directly or via the membrane frame 140, to a second end part 126 (illustrated for one suspension element each in FIGS. 1a, 2a and 5a-e) that is attached to the outer frame part 110 of the support structure 100. Although not illustrated in FIG. 8, the same of course applies to each of the suspension element 820a, 820b, wherein the first end part 124 is either attached to the flexible membrane 830, directly or via the membrane frame 140, or is the membrane facing end part that is attached to the adjacent intermediate frame 860 that is located radially towards the center of the flexible membrane 830 compared to the suspension element 820a.

By the suspension element(s) extending or having their main extension in a direction that deviates significantly from the radial direction, this increases a stroke length of the at least one suspension element and thereby also the amplitude at low frequencies for the MEMS-based micro speaker compared to if the suspension element would extend radially from the flexible membrane. Providing the at least one suspension element to extend in a tangential main direction or at an angle of at least 45 degrees from a radial direction, preferably at least 60 degrees from a radial direction, more preferably at least 80 degrees from a radial direction, from their attachment to the flexible membrane is thus advantageous both in comparison to providing the at least one suspension element to extend substantially radially from the flexible membrane and in comparison to prior art solutions using clamped membranes.

Each of the at least one suspension element 120, 820a, 820b may be arranged to pivot around a first axis A that is radially directed towards the center of the flexible membrane 130, 830 through the center of the suspension element 120, 820a, 820b. The first axis A is shown in FIGS. 1a, 2a and 8. Thereby, the amplitude of the MEMS-based micro speaker is increased since the stroke length of the at least one suspension element 120, 820a, 820b is increased.

In some embodiments, each of the at least one suspension element 120, 820b is fixed to the flexible membrane 130, 830 directly (as shown in e.g. FIG. 1a) or via a membrane frame 140, 840, (as e.g. shown in FIG. 2a) along a first attachment section 134 on the periphery of the flexible membrane 130, 830 or on the periphery of the membrane frame 140, 840. The length of the first attachment section 134 is less than 10 % of the length of the periphery of the flexible membrane 130, 830 or the membrane frame 140, 840. Thereby, movement of the at least one suspension element 120, 820b in relation to the flexible membrane 130, 830 or membrane frame 140, 840 is improved, providing a larger vertical gap for the MEMS-based micro speaker and hence greater amplitude in “piston mode”.

Similarly, in some embodiments, each of the at least one suspension element 120, 820a, 820b is fixed to or extends as an integrated part from the outer frame part 110, 810 along a second attachment section 114, the length of the second attachment section 114 being less than 10 % of the length of the periphery of the flexible membrane. Thereby, movement of the at least one suspension element in relation to the outer frame is improved, providing a larger vertical gap for the MEMS-based micro speaker and hence greater amplitude in “piston mode”.

In embodiments wherein there are only one or two suspension elements 120 or only on or two suspension elements 820a, 820b in each level of nesting, the first attachment sections 134 may be wider, for example up to 25% of the length of the periphery, and still maintaining the advantageous effects of large deflection compared to membranes attached along all (clamped membranes) or a larger part of the periphery of the flexible membrane. Similarly, in these cases the second attachment sections 114 may also be wider, for example up to 25% of the length of the periphery, and still maintaining the advantageous effects of large deflection compared to membranes attached along all (clamped membranes) or a larger part of the periphery of the flexible membrane.

In any embodiment herein, all first attachment sections 134 for one MEMS-based micro speaker need not have the same length but may vary. Similarly, in any embodiment herein, all second attachment sections 114 for one MEMS-based micro speaker need not have the same length but may vary.

In embodiments wherein there is only one suspension element 120 enclosing the flexible membrane 130 (and the membrane frame 140 if there is one), the suspension element 120 is fixed to the flexible membrane 130, directly or via the membrane frame 140 along more than one first attachment section 134. This is illustrated in FIG. 5a by the first attachment sections 134′, 134″, 134″′ and 134″. In these embodiments, the suspension element 120 is fixed to or extends as an integrated part from the outer frame part 110 along more than one second attachment section 114. This is illustrated in FIG. 5a by the second attachment sections 114′, 114″, 114″′ and 114″. This applies similarly to every level of the nested MEMS-based micro speakers described herein.

The flexible membrane 130, 830 may be made of silicon. The membrane frame 140, 840, and/or intermediate frame(s) 860 may also be made of silicon. In this case, the cross-section thickness DF of the membrane frame 140, 840 and/or intermediate frame(s) 860 is larger than the thickness DM of the flexible membrane 130, 830, thereby making the membrane frame less flexible than the flexible membrane 130, 830. Silicon is a highly suitable material that is both flexible and durable, thereby ensuring a long lifetime and a continuously high performance also when the MEMS-based micro speaker is used for long durations of time. Furthermore, it is advantageous to use silicon for both the membrane frame 140, 840 and/or intermediate frame(s) 860 and the flexible membrane 130, 830 itself since this renders manufacture significantly easier than when different materials are used and since the risk of damage or even tears to the flexible membrane at its attachment to the membrane frame is avoided.

Since the mass of the membrane frame 140, 840 and/or intermediate frame(s) 860 significantly affects the suspension resonance frequency (or frequencies in the case of a nested device), the membrane frame 140, 840 and/or intermediate frame(s) 860 should be designed in order to have a mass appropriate for the desired behavior. In order to tune the mass of the membrane frame 140, 840 and/or intermediate frame(s) 860 without sacrificing the stabilizing properties, rather than just making the walls of the respective frame thinner or shorter, an alternative is to build the frame by thin walls connected in a truss structure, as illustrated in the non-limiting example of FIG. 4. The thin walls may e.g. have a thickness of less than 33% of the total frame truss structure thickness. By adjusting the width and spacing of the walls, the total mass of the membrane frame 140 can be adjusted without overly affecting the mechanical behavior of the membrane frame structure. Alternatively, or additionally, the mass of the membrane frame 140, 840 and/or intermediate frame(s) 860 and thereto connected properties may be controlled by adjusting the width of the respective frame and/or selecting a suitable frame material of a desired density to suit the purpose at hand.

As illustrated in the figures, the MEMS-based micro speaker contains narrow through openings between at least one suspension element 120, 820a, 820b and the outer frame part 110, 810 of the support structure 100, 800 as well as between the at least one suspension element 120, 820a, 820b and the flexible membrane 130, 830. These openings are configured to allow fluid, typically air, to pass through the first openings respectively. It is well known in the art that it is in many circumstances desirable to seal openings between components in a micro speaker to prevent fluid leakage between the components. In some embodiments, as illustrated in FIGS. 7a and 7b, the MEMS-based micro speaker further comprises a flexible polymer membrane 150 covering the at least one suspension element 120, 820a, 820b, the flexible membrane 130, 830, any frames 140, 840, 860, and the support structure 100, 800, such that: in a neutral positioning NP of the at least one suspension element 120, 820a, 820b, as illustrated in FIG. 7a, the flexible polymer membrane 150 is folded to form a fold F1, F2 between a respective outer edge 128 of each suspension element 120, 820a, 820b and the outer frame part 110 of the support structure 100. In a first extreme positioning EP1 of the at least one suspension element 120, 820a, 820b, as illustrated in FIG. 7b, the flexible polymer membrane 150 is unfolded to cover a spacing UF1, UF2 between the respective outer edge 128 of each suspension element 120, 820a, 820b and the outer frame part 110, 810 of the support structure 100, 800. Thereby, the flexible polymer membrane 150 is advantageously arranged to prevent fluid leakage between at least one suspension element 120, 820a, 820b and the outer frame part 110, 810 of the support structure 100, 800 as well as between the at least one suspension element 120, 820a, 820b and the flexible membrane. In the example of FIG. 7b, the at least one suspension element 120, 820a, 820b are in the first extreme positioning EP1, extending upwards, i.e. in the direction of the flexible polymer membrane 150. During actuation, the at least one suspension element 120, 820a, 820b will of course after reaching the first extreme positioning EP1 move away from the first extreme positioning EP1 along the second axis B, pass the neutral positioning of FIG. 7a again and move to a second extreme positioning EP2. This second extreme positioning EP2 is not shown in the figures. Consequently, while avoiding air/fluid leakage, only a small amount of energy is further required to stretch the flexible polymer membrane 150 compared to if an unfolded polymer membrane was used, and therefore a relatively large amount of the supplied energy may be used to produce sound.

In a nested configuration, the folds F1, F2 are located between the outermost suspension element(s) and the outer frame part 810 of the support structure 800. Consequently, while avoiding air leakage, only a small amount of energy is required to stretch the flexible polymer membrane 150, and therefore a relatively large amount of the supplied energy may be used to produce sound.

The geometry of the flexible membrane 130 may vary. For example, it is possible to add slits to increase the deflection and tune the frequency response. FIG. 6a to c show some non-limiting examples of flexible membrane 130 configurations with and without slits 600, which may be used in the MEMS-based micro speaker and/or system 200 according to any embodiment presented herein.

In a second aspect, the invention includes a MEMS-based micro speaker system 200, which will now be described with reference to FIG. 3.

FIG. 3 shows a schematic view of a MEMS-based micro speaker system comprising at least one MEMS-based micro speaker according to any of the embodiments described herein and a controller 210.

The MEMS-based micro speaker comprises a support structure 100, 800 with an outer frame part 110, 810 and at least one suspension element 120, 820a, 820b, each suspension element 120, 820a, 820b being connected to a respective at least one first piezoelectric actuator 122, 122′, 122″ on the suspension element 120, 820a, 820b. The support structure 100, 800 further comprises a flexible membrane 130, 830 being fixed to the at least one suspension element 120, 820a, 820b, the flexible membrane 130, 830 being connected to a second piezoelectric actuator 132, 132′, 132″ on the flexible membrane 130, 830. The flexible membrane 130, 830 is surrounded by the support structure 100, 800 in the plane represented by the outer frame part of the support structure 100, 800. Thereby, the suspension resonance frequency is lower than the membrane resonance frequency. In other words, the dimensions of the at least one suspension element 120, 820a, 820b and the flexible membrane 130, 830 are chosen such that the suspension resonance frequency is lower than the membrane resonance frequency. For nested micro speakers, the internal relations between nested sets of suspension elements 820a, 820b further apply as described in connection with FIG. 8.

The controller 210 is configured to generate a control signal C configured to actuate the at least one first piezoelectric actuator 122, 122′, 122″ so as to influence a position of a membrane facing end of the at least one suspension element 120, 820a, 820b along the second axis B perpendicular to a plane represented by the outer frame part of the support structure 100, 800, and to actuate the second piezoelectric actuator 132, 132′, 132″ so as to deflect the flexible membrane 130, 830. Thereby, the advantages of the MEMS-based micro speaker, including enabling generation of sound in both low frequency modes and high frequency modes of the MEMS-based micro speaker, are realized in a space efficient micro speaker system.

The MEMS-based micro speaker can be the MEMS-based micro speaker according to any embodiment described in connection with FIGS. 1a to 2b and/or FIGS. 4 to 10c. Regarding choosing the dimensions of the at least one suspension element 120, 820 and the flexible membrane 130, 830 such that the suspension resonance frequency is lower than the membrane resonance frequency, there are as the skilled person understands many ways to affect or change the resonance frequency of the sound pressure generating elements (the at least one suspension element 120, 820 and the flexible membrane 130, 830), e.g. by altering the size of the flexible membrane 130, 830 (in the plane represented by the outer frame part 110, 810 of the support structure 100, 800), the thickness of the flexible membrane 130, 830 (extension perpendicular to the plane represented by the outer frame part 110, 810 of the support structure 100, 800), the length of the suspension element(s) 120, 820a, 820b, the width of the suspension element(s) 120, 820 (in the plane represented by the outer frame part 110, 810 of the support structure 100, 800) and/or thickness of the suspension element(s) 120, 820 (perpendicular to the plane represented by the outer frame part 110, 810 of the support structure 100, 800). For the purpose of the invention, any detailed adjustments of resonance frequencies may be made within the scope of embodiments presented herein, as long as the main relation between the flexible membrane 130, 830 and the support structure 100, 800, including the at least one suspension element 120, 820, is fulfilled-namely that the flexible membrane 130, 830 is surrounded by the support structure 100, 800 in the plane represented by the outer frame part 110, 810 of the support structure 100, 800, which ensures that the resonance frequency of each of the at least one suspension element 120, 820a, 820b is lower than the actuation frequency of the flexible membrane 130, 830. For nested micro speakers, the additional relations between first, second and possibly additional nested sets of suspension elements 820a, 820b also applies, as described in connection with FIG. 8.

The first piezoelectric actuator 122, 122′, 122″ of each of the at least one suspension element 120, 820a, 820b is controllable in response to the control signal C so as to influence a position of the first end part 124 of the suspension element 120, 820a, 820b along a second axis B perpendicular to a plane represented by the outer frame part 110, 810 of the support structure 100, 800. The plane represented by the outer frame part 110, 810 of the support structure is the plane in which the entire support structure 100 extends in a non-actuated state. The first end part 124 is either attached to the flexible membrane 130, 830, or the membrane frame 140, 840 or an intermediate frame 860 if such frame(s) is/are comprised in the MEMS-based micro speaker. The first end part 124 may also be referred to as the membrane facing end part 124. Each of the at least one suspension element 120, 820a, 820b is then configured to alter the position of the end 124 of the suspension element 120, 820a, 820b that is attached to the flexible membrane 130, 830 along the axis B in response to the control signal C influencing the second piezoelectric actuator 132, 132′, 132″. The second piezoelectric actuator 132, 132′, 132″ is controllable in response to the control signal C so as to deflect the flexible membrane 130, 830. The flexible membrane 130 is in turn configured to be deflected in response to the control signal C influencing the second piezoelectric actuator 132, 132′, 132″.

The control signal C may also be referred to as a drive signal or an actuation signal. The control signal C may comprise a first and a second control signal, C1 and C2, wherein the first control signal C1 is configured to actuate the first piezoelectric actuator 122 and the second control signal C2 is configured to actuate the second piezoelectric actuator 132, via separate routings. Of course, the control signal C may comprise more than two signals C1, C2, if this is required or desirable in a certain application. Suitably, as the inventors have realized, the need for separate routings and separate control signals can be eliminated or reduced by the use of membrane frames 140, 840, and one or more intermediate frames 860 for nested micro speaker, as described herein.

Each first piezoelectric actuator 122 and/or second piezoelectric actuator 132 may comprise several actuator sections, which may be controlled separately by separate control signals, separate parts of the control signal C, or commonly by the control signal C. FIG. 10a to c illustrate example configurations of piezoelectric layers, i.e. configurations of first and second piezoelectric actuators 122, 132. The actuation of both the suspension elements 120, 820a, 820b and the central flexible membrane 130, 830 is done by piezoelectric layers in the form of first and second piezoelectric actuators 122, 132 on the elements to be actuated, which creates bending forces when a voltage is applied via the control signal C.

FIG. 10a shows a MEMS-based micro speaker according to embodiments herein, wherein each first and second piezoelectric actuator 122, 132 consists of a single section covering or substantially covering the surface of the respective element to be actuated.

FIG. 10b illustrates an alternative configuration wherein the second piezoelectric actuator 132 partly covers the surface of the flexible membrane 130, 830 compared to in the example in FIG. 10a. Similarly, each first piezoelectric actuator 122 connected to a respective suspension element 120, 820a, 820b partly covers the surface of the respective suspension element 120, 820a, 820b to be actuated compared to in the example in FIG. 10a.

FIG. 10c illustrates yet another alternative configuration, wherein each of the first piezoelectric actuator 122 is divided into a first section 122′and a second section 122″. Similarly, the second piezoelectric actuator 132 is divided into a first section 132′and a second section 132″. During operation of the MEMS-based micro speaker, the first parts 122′, 132′of the first and second piezoelectric actuators are driven, or controlled in manners described herein, in phase, while the second parts 122″, 132″ of the first and second piezoelectric actuators are driven in counter-phase compared to the first parts 122′, 132′.

Of course, the options for configurations of the first and second piezoelectric actuators 122, 132 are not limited to the examples illustrated in the schematic figures. Instead, the size, shape, and position of the first and second piezoelectric actuators 122, 132, or sections thereof, and the resulting coverage of the elements to be actuated, as well as driving sections in phase or counter-phase, may be varied to suit the application at hand.

It is generally advantageous if the controller 210 is configured to generate the control signal C in an automatic manner by executing a computer program 227. Therefore, the controller 210 may include a memory unit 225, i.e. non-volatile data carrier, storing the computer program 227, which, in turn, contains software for making processing circuitry in the form of at least one processor 223 in the controller 210 generate the control signal C and control, or actuate, the first and second piezoelectric actuator 122, 132 by the control signal C when the computer program 227 is run on the at least one processor 223. In one or more embodiment, the invention may therefore comprise a computer program 227 loadable into a non-volatile data carrier 225 communicatively connected to a processor 223, the computer program 227 comprising executable software which causes the controller 210 to generate the control signal C and control, or actuate, the first and second piezoelectric actuator 122, 132 by the control signal C when the computer program 227 is run on the processor 223. Furthermore, the invention may comprise a non-volatile data carrier 225 containing the computer program 227.

The actions performed by the controller 210 may be controlled by means of a programmed processor. Moreover, although the embodiments described above with reference to the drawings comprise a processor and processes performed in at least one processor, the invention thus also extends to computer programs, particularly computer programs on or in a carrier, adapted for putting relevant process steps of the invention into practice. The program may be in the form of source code, object code, a code intermediate source and object code such as in partially compiled form, or in any other form suitable for use in the implementation of the process according to the invention. The program may either be a part of an operating system or be a separate application. The carrier may be any entity or device capable of carrying the program. For example, the carrier may comprise a storage medium, such as a Flash memory, a ROM (Read Only Memory), for example a DVD (Digital Video/Versatile Disk), a CD (Compact Disc) or a semiconductor ROM, an EPROM (Erasable Programmable Read-Only Memory), an EEPROM (Electrically Erasable Programmable Read-Only Memory), or a magnetic recording medium, for example a floppy disc or hard disc. Further, the carrier may be a transmissible carrier such as an electrical or optical signal which may be conveyed via electrical or optical cable or by radio or by other means. When the program is embodied in a signal, which may be conveyed, directly by a cable or other device or means, the carrier may be constituted by such cable or device or means. Alternatively, the carrier may be an integrated circuit in which the program is embedded, the integrated circuit being adapted for performing, or for use in the performance of, the relevant processes.

Variations to the disclosed embodiments can be understood and effected by those skilled in the art in practicing the claimed invention, from a study of the drawings, the disclosure, and the appended claims.

The term “comprises/comprising” when used in this specification is taken to specify the presence of stated features, integers, steps, or components. The term does not preclude the presence or addition of one or more additional elements, features, integers, steps or components or groups thereof. The indefinite article “a” or “an” does not exclude a plurality. In the claims, the word “or” is not to be interpreted as an exclusive or (sometimes referred to as “XOR”). On the contrary, expressions such as “A or B” covers all the cases “A and not B”, “B and not A” and “A and B”, unless otherwise indicated. The mere fact that certain measures are recited in mutually different dependent claims does not indicate that a combination of these measures cannot be used to advantage. Any reference signs in the claims should not be construed as limiting the scope.

It is also to be noted that features from the various embodiments described herein may freely be combined, unless it is explicitly stated that such a combination would be unsuitable.

The invention is not restricted to the described embodiments in the figures but may be varied freely within the scope of the claims.

1. A MEMS-based micro speaker comprising:
a support structure comprising an outer frame part and at least one suspension element each suspension element being connected to a respective at least one first piezoelectric actuator on the suspension element that creates bending forces on the at least one suspension element that influence a position of a membrane facing end of the at least one suspension element along a second axis perpendicular to a plane represented by the outer frame part of the support structure when a voltage is applied; and
a flexible membrane being fixed to the at least one suspension element, the flexible membrane being connected to a second piezoelectric actuator on the flexible membrane that creates bending forces on the flexible membrane that deflect the flexible membrane when a voltage is applied,
wherein the flexible membrane is surrounded by the support structure in the plane represented by the outer frame part of the support structure, whereby the resonance frequency of each of the at least one suspension element is lower than the actuation frequency of the flexible membrane.

2. The MEMS-based micro speaker according to claim 1, further comprising a membrane frame fixed to the periphery of the flexible membrane, wherein the flexible membrane is fixed to the at least one suspension element via the membrane frame.

3. The MEMS-based micro speaker according to claim 1, wherein the at least one suspension element extends from the flexible membrane at an angle of one of: (i) at least 45 degrees, (ii) at least 60 degrees, or (iii) at least 80 degrees from a radial direction.

4. The MEMS-based micro speaker according to claim 1, wherein the at least one suspension element extends in a direction tangential to the periphery of the flexible membrane.

5. The MEMS-based micro speaker according to claim 1, wherein each of the at least one suspension element is arranged to pivot around a first axis, wherein the first axis is radially directed towards a center of the flexible membrane through a center of the suspension element.

6. The MEMS-based micro speaker according to claim 1, wherein the flexible membrane is made of silicon.

7. The MEMS-based micro speaker according to claim 2, wherein the membrane frame and the flexible membrane are made of silicon and wherein the cross-section thickness of the membrane frame is larger than the thickness of the flexible membrane, thereby making the membrane frame less flexible than the flexible membrane.

8. The MEMS-based micro speaker according to claim 2, wherein each of the at least one suspension element is fixed to the flexible membrane, directly or via the membrane frame, along a first attachment section on the periphery of the flexible membrane or the membrane frame, a length of the attachment section being less than 10 % of a length of the periphery of the flexible membrane or the membrane frame.

9. The MEMS-based micro speaker according to claim 1, wherein each of the at least one suspension element is fixed to or extends as an integrated part from the outer frame part along a second attachment section, a length of the second attachment section being less than 10 % of a length of the periphery of the flexible membrane.

10. The MEMS-based micro speaker according to claim 2, wherein each of the at least one suspension element is fixed to or extends as an integrated part from the outer frame part along a second attachment section, a length of the second attachment section being less than 10 % of a length of the periphery of the flexible membrane, wherein the membrane frame consists of thin walls arranged in a truss structure.

11. The MEMS-based micro speaker according to claim 1, further comprising a flexible polymer membrane covering the at least one suspension element, the flexible membrane, and the support structure, such that:
in a neutral positioning of the at least one suspension element, the flexible polymer membrane is folded to form a fold between a respective outer edge of each suspension element and the outer frame part of the support structure, and
in a first extreme positioning of the at least one suspension element, the flexible polymer membrane is unfolded to cover a spacing between the respective outer edge of each suspension element and the outer frame part of the support structure.

12. The MEMS-based micro speaker according to claim 1, wherein the flexible membrane has a curved or circular outline and wherein each of the at least one suspension element has the shape of a single continuous curve, or two or more connected curve segments, each extending in a direction tangential to the periphery of the flexible membrane.

13. The MEMS-based micro speaker according to claim 1, wherein the flexible membrane has a rectilinear outline and wherein each of the at least one suspension element has the shape of a single elongated rectilinear segment, or two or more connected elongated rectilinear segments.

14. A micro speaker system comprising:
a MEMS-based micro speaker comprising a support structure comprising:
an outer frame part and at least one suspension element, each suspension element being connected to a respective at least one first piezoelectric actuator on the suspension element; and
a flexible membrane being fixed to the at least one suspension element, the flexible membrane being connected to a second piezoelectric actuator on the flexible membrane,
wherein the flexible membrane is surrounded by the support structure in the plane represented by the outer frame part of the support structure, whereby the suspension resonance frequency is lower than the membrane resonance frequency; and
a controller configured to generate a control signal configured to actuate the at least one first piezoelectric actuator so as to influence a position of a membrane facing end of the at least one suspension element along a second axis perpendicular to a plane represented by the outer frame part of the support structure, and to actuate the second piezoelectric actuator so as to deflect the flexible membrane.

15. The micro speaker system according to claim 14, wherein the MEMS-based micro speaker further comprises a membrane frame fixed to the periphery of the flexible membrane, wherein the flexible membrane is fixed to the at least one suspension element via the membrane frame.

16. The micro speaker system according to claim 14, wherein the first piezoelectric actuator of each of the at least one suspension element is controllable in response to the control signal so as to influence a position of the membrane facing end of the suspension element, which is attached to the flexible membrane, along the second axis perpendicular to the plane represented by the outer frame part of the support structure.

17. The micro speaker system according to claim 14, wherein the second piezoelectric actuator is controllable in response to the control signal so as to deflect the flexible membrane.

18. The micro speaker system according to claim 14, wherein the at least one suspension element extends from the flexible membrane at an angle of one of: (i) at least 45 degrees, (ii) at least 60 degrees, or (iii) at least 80 degrees from a radial direction.

19. The micro speaker system according to claim 14, wherein the at least one suspension element extends in a direction tangential to the periphery of the flexible membrane.

20. The micro speaker system according to claim 14, wherein each of the at least one suspension element is arranged to pivot around a first axis, wherein the first axis is radially directed towards a center of the flexible membrane through a center of the suspension element.
